(19) United States
(12) Patent Application Publication
(10) Pub. No.: US 2016/0196034 A1
(43) Pub. Date: Jul. 7, 2016

(54) Touchscreen Control Method and Terminal Device

(71) Applicant: Huawei Device Co., Ltd., Shenzhen (CN)

(72) Inventor: Lei Chen, Beijing (CN)

(21) Appl. No.: 14/901,820

(22) PCT Filed: Nov. 25, 2014
(86) PCT No.: PCT/CN2014/092144

§ 371 Date: Dec. 29, 2015

(30) Foreign Application Priority Data
Nov. 28, 2013 (CN) 201310625612.5

(51) Int. Cl. G06F 3/0481; G06F 3/0488

(52) U.S. Cl. CPC G06F 3/04812; G06F 3/0488

(57) ABSTRACT

A touchscreen control method and a terminal device. When a touchscreen is in a non-contact touch state, the terminal acquires touch information of a touch point in a control region. The control region is a region above the touchscreen, the control region is parallel to a plane in which the touchscreen is located, and an area of the control region is less than an area of the touchscreen. The terminal controls movement of a cursor on the touchscreen according to the acquired touch information of the touch point and a correspondence between the touch point and a pixel of the touchscreen.

### CROSS-REFERENCE TO RELATED APPLICATIONS

This application is a National Stage of International Application No. PCT/CN2014/092144, filed on Nov. 25, 2014, which claims priority to Chinese Patent Application No. 201310625612.5, filed on Nov. 28, 2013, both of which are hereby incorporated by reference in their entireties.

### TECHNICAL FIELD

The present disclosure relates to the field of communications technologies, and in particular, to a touchscreen control method and a terminal device.

### BACKGROUND

With the development of touchscreen technologies, screens of multiple existing terminal products may use a touchscreen to implement display and control. These terminal products are, for example, a mobile phone, a tablet computer, and a digital camera.

In order to meet requirements of users, touchscreens of terminal products are increasingly larger. Compared with a smaller touchscreen, a larger touchscreen has a better effect in displaying a game, a video, a picture, and the like.

However, due to an extremely large touchscreen, when a terminal product is being used, one-hand operations cannot be performed.

### SUMMARY

Embodiments of the present disclosure provide a touchscreen control method and a terminal device, so as to resolve a problem in the prior art that a terminal product with a relatively large touchscreen cannot be operated with one hand.

To resolve the foregoing technical problem, the embodiments of the present disclosure disclose the following technical solutions.

According to a first aspect, a touchscreen control method is provided, and the method includes when a touchscreen is in a non-contact touch state, acquiring touch information of a touch point in a control region, where the control region is a region above the touchscreen, the control region is parallel to a plane in which the touchscreen is located, and an area of the control region is less than an area of the touchscreen; and controlling movement of a cursor on the touchscreen according to the acquired touch information of the touch point and a correspondence between the touch point and a pixel of the touchscreen.

In a first possible implementation manner of the first aspect, the acquired touch information of the touch point includes acquired information about the touch point that is touched, and acquired touch track information.

With reference to the first possible implementation manner of the first aspect, in a second possible implementation manner of the first aspect, the controlling movement of a cursor on the touchscreen according to the acquired touch information of the touch point and a correspondence between the touch point and a pixel of the touchscreen includes displaying, according to the acquired information about the touch point that is touched, the cursor at the pixel of the touchscreen corresponding to the touch point that is touched; and controlling, according to the acquired touch track information, the cursor to move on the touchscreen in a track corresponding to the track information, where the track that is on the touchscreen and corresponding to the track information is obtained from the correspondence between the touch point and the pixel of the touchscreen.

With reference to the first aspect or the first possible implementation manner or the second possible implementation manner of the first aspect, in a third possible implementation manner of the first aspect, the correspondence between the touch point and the pixel of the touchscreen is a proportional scaling correspondence or a non-proportional scaling correspondence.

With reference to the first aspect or the first possible implementation manner or the second possible implementation manner of the first aspect, in a fourth possible implementation manner of the first aspect, the method further includes when it is detected that the touchscreen is contact-touched, executing an operation corresponding to touch of a current location of the cursor.

According to a second aspect, a terminal device that includes a touchscreen is provided, including an acquiring module configured to when the touchscreen is in a non-contact touch state, acquire touch information of a touch point in a control region; and transmit the acquired touch information of the touch point in the control region to a control module, where the control region is a region above the touchscreen, the control region is parallel to a plane in which the touchscreen is located, and an area of the control region is less than an area of the touchscreen; and the control module configured to control movement of a cursor on the touchscreen according to the acquired touch information of the touch point and a correspondence between the touch point and a pixel of the touchscreen.

In a first possible implementation manner of the second aspect, the acquiring module is further configured to when the touchscreen is in the non-contact touch state, acquire information about the touch point that is touched, and acquire touch track information.

With reference to the first possible implementation manner of the second aspect, in a second possible implementation manner of the second aspect, the control module includes a display submodule configured to display, according to the acquired information about the touch point that is touched, the cursor at the pixel of the touchscreen corresponding to the touch point that is touched; and a control submodule configured to control, according to the acquired touch track information, the cursor to move on the touchscreen in a track corresponding to the track information, where the track that is on the touchscreen and corresponding to the track information is obtained from the correspondence between the touch point and the pixel of the touchscreen.

With reference to the second aspect or the first possible implementation manner or the second possible implementation manner of the second aspect, in a third possible implementation manner of the second aspect, the correspondence between the touch point and the pixel of the touchscreen is a proportional scaling correspondence or a non-proportional scaling correspondence.

With reference to the second aspect or the first possible implementation manner or the second possible implementation manner of the second aspect, in a fourth possible implementation manner of the second aspect, the terminal device further includes a detecting module configured to detect whether the touchscreen is contact-touched and transmit a detection result to an execution module; and the execution module configured to when receiving a detection result that the touchscreen is contact-touched, execute an operation corresponding to touch of a current location of the cursor.

In the embodiments of the present disclosure, when a touchscreen is in a non-contact touch state, movement of a cursor on the touchscreen is controlled according to acquired touch information of a touch point in a control region and a correspondence between the touch point and a pixel of the touchscreen, so that the entire touchscreen is controlled. An area of the control region is less than an area of the touchscreen. Therefore, a user can control a larger-area touchscreen by using a smaller-area control region, so that the user can perform one-hand operations.

### BRIEF DESCRIPTION OF DRAWINGS

To describe the technical solutions in the embodiments of the present disclosure or in the prior art more clearly, the following briefly introduces the accompanying drawings required for describing the embodiments or the prior art. The accompanying drawings in the following description show some embodiments of the present disclosure, and a person of ordinary skill in the art may still derive other drawings from these accompanying drawings without creative efforts.

FIG. 1 is a schematic structural diagram of a prior-art capacitive sensor;

FIG. 2 is a schematic structural diagram of a prior-art mutual capacitance sensor;

FIG. 3 is a schematic structural diagram of a prior-art self-capacitance sensor;

FIG. 4 is a flowchart of a method according to Embodiment 1 of the present disclosure;

FIG. 5 is a flowchart of a method according to Embodiment 2 of the present disclosure;

FIG. 6A and FIG. 6B are a schematic diagram of a correspondence between a pixel of a touchscreen and a touch point of a control region according to Embodiment 2 of the present disclosure;

FIG. 7 is a schematic structural diagram of a terminal device according to Embodiment 3 of the present disclosure; and

FIG. 8 is a schematic structural diagram of a terminal device according to Embodiment 4 of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are a part rather than all of the embodiments of the present disclosure. All other embodiments obtained by a person of ordinary skill in the art based on the embodiments of the present disclosure without creative efforts shall fall in the protection scope of the present disclosure.

In the following, specific implementation manners of the present disclosure are further described in detail with reference to the accompanying drawings and the embodiments. The following embodiments are used for illustrating the present disclosure, but not limiting the scope of the present disclosure.

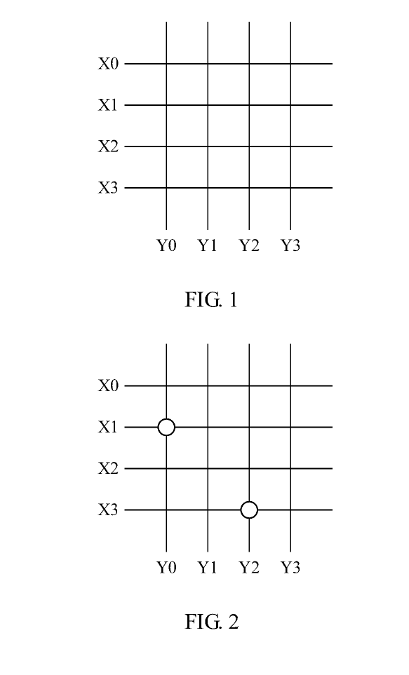

A prior-art touchscreen generally uses a capacitive sensor to implement touch sensing. As shown in FIG. 1, the capacitive sensor works by means of X-Y grid electrode wires that cover a screen of a mobile phone, and a touch point is formed at an intersection point of an X electrode wire and a Y electrode wire. When a finger approaches the touch point, capacitance changes and can be measured. A location of the finger may be accurately determined by comparing measurement values of all touch points.

Existing capacitive sensors include mutual capacitance sensors and self-capacitance sensors.

In a mutual capacitance sensor, as shown in FIG. 2, each touch point forms a parallel-plate capacitor, which means that each touch point is a capacitor, and then it is ensured that measurement is accurate to a touch point touched by each finger, so that multi-touch control can be implemented. However, an area of an intersection point of two electrode wires is extremely small, which makes an electric field of the mutual capacitance sensor extremely small as well, so that signal strength is extremely low, and extremely weak signals cannot be sensed. Therefore, when a finger of a user hovers above the screen, the mutual capacitance sensor cannot sense a signal; only when the finger touches the screen, related interrupt information can be generated and touch coordinates can be reported.

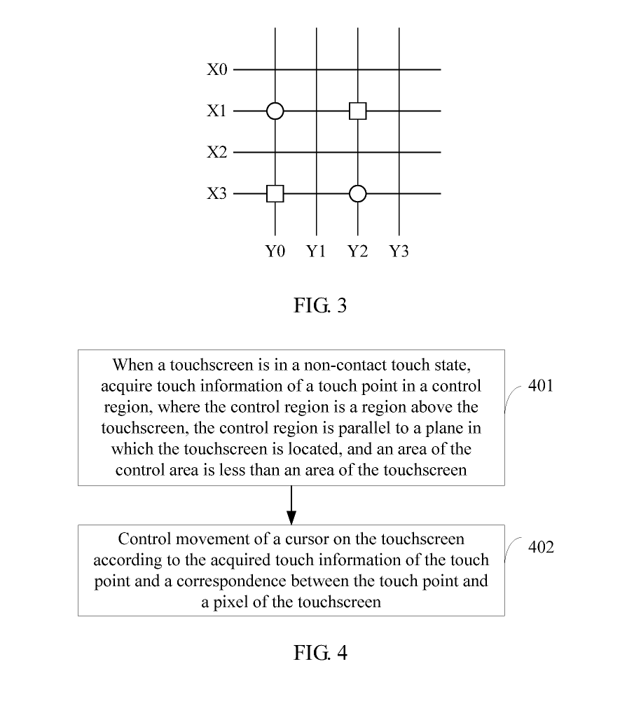

In a self-capacitance sensor, as shown in FIG. 3, each X electrode wire or Y electrode wire is a capacitor. Obviously, an electric field of the self-capacitance sensor is greater than the electric field of the mutual capacitance sensor, so that a stronger signal may be created, which enables the self-capacitance sensor to detect a finger that suspends 20 mm above the screen. However, a problem known as “ghost” exists when the self-capacitance sensor detects a multi-touch. For example, when a finger stays at a touch point (X1, Y0), an X1 electrode wire and a Y0 electrode wire that are nearest the finger are activated, so that the touch point (X1, Y0) is determined; however, if it is detected that two fingers respectively stay at touch points (X1, Y0) and (X3, Y2), four electrode wires X1, X3, Y0, and Y3 are activated, and there are four possible touch points (X1, Y0), (X1, Y2), (X3, Y0), and (X3, Y2), so that real touch points cannot be determined. This is the so called “ghost” problem. Therefore, the self-capacitance sensor cannot implement multi-touch detection.

A prior-art touchscreen control principle is as follows: The touchscreen displays image or text information by using a pixel array that is externally set, and senses a touch of a user by using a touch point array that is internally set. The touch point array covers the entire touchscreen, and a correspondence is established between the touch point array and the pixel array of the touchscreen. If a touch point of the touchscreen senses a touch of a finger of the user, it is considered that image or text information displayed at a location of a pixel corresponding to the touch point is selected.

### Embodiment 1

Based on the foregoing touchscreen control principle, a first embodiment of the present disclosure provides a touchscreen control method, where the method is shown in FIG. 4, and the method includes the following steps:

Step 401: When a touchscreen is in a non-contact touch state, acquire touch information of a touch point in a control region, where the control region is a region above the touchscreen, the control region is parallel to a plane in which the touchscreen is located, and an area of the control region is less than an area of the touchscreen.

Step 402: Control movement of a cursor on the touchscreen according to the acquired touch information of the touch point and a correspondence between the touch point and a pixel of the touchscreen.

In this embodiment of the present disclosure, when a touchscreen is in a non-contact touch state, movement of a cursor on the touchscreen is controlled according to acquired touch information of a touch point in a control region and a correspondence between the touch point and a pixel of the touchscreen, so that the entire touchscreen is controlled. An area of the control region is less than an area of the touchscreen. Therefore, a user can control a larger-area touchscreen by using a smaller-area control region, so that the user can perform one-hand operations.

In this embodiment of the present disclosure, by using acquired information about a touch point that is touched, a cursor is displayed at a pixel of the touchscreen corresponding to the touch point that is touched, and according to acquired touch track information, the cursor is controlled to move on the touchscreen in a track corresponding to the track information, so that the entire touchscreen is controlled by using the control region, and then one-hand operations of a user can be performed.

### Embodiment 2

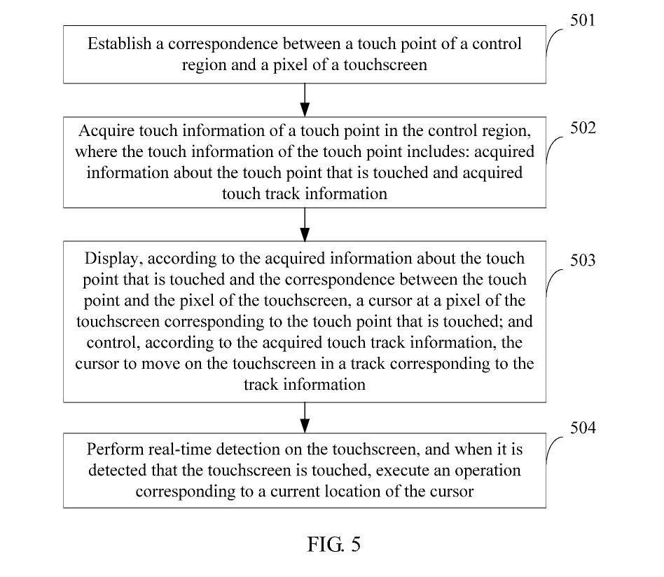

According to content of Embodiment 1, a second embodiment of the present disclosure provides a touchscreen control method. The method is used when a touchscreen is in a non-contact touch state. Before implementing the method, a user may set a control region of a terminal device according to his/her own needs, where the control region includes multiple touch points. A flowchart of the method is shown in FIG. 5, and the method includes the following steps:

Step 501: Pre-establish a correspondence between a touch point of the control region and a pixel of the touchscreen.

It should be noted that step 501 may be executed before the terminal device is delivered from the factory. That is, before the terminal device is delivered, the control region may be preset, and the correspondence between the control region and the touchscreen may be established; or a terminal user may set the control region and establish the correspondence between the control region and the touchscreen. This step may not need to be executed each time when this method is executed.

The control region is a region above the touchscreen, the control region is parallel to a plane in which the touchscreen is located, and an area of the control region is less than an area of the touchscreen.

In this embodiment of the preset disclosure, the user may set the control region in a lower right corner or a lower left corner of the touchscreen according to his/her own needs, so as to facilitate one-hand operations of the user and setting of the control region in a landscape or portrait mode.

In this embodiment of the present disclosure, the correspondence between the touch point and the pixel of the touchscreen is a proportional scaling correspondence or a non-proportional scaling correspondence.

When the correspondence between the touch point and the pixel of the touchscreen is a proportional scaling correspondence, a relationship between touch points of the control region and touch points of the touchscreen is as follows. The control region includes touch points of a rows and b columns, and the touchscreen includes pixels of ma rows and mb columns, where a touch point in the x^{th} row and the y^{th} column in the control region is corresponding to a pixel in the mx^{th} row and the my^{th} column in the touchscreen, and a, b, m, x, and y are all integers that are greater than or equal to 1.

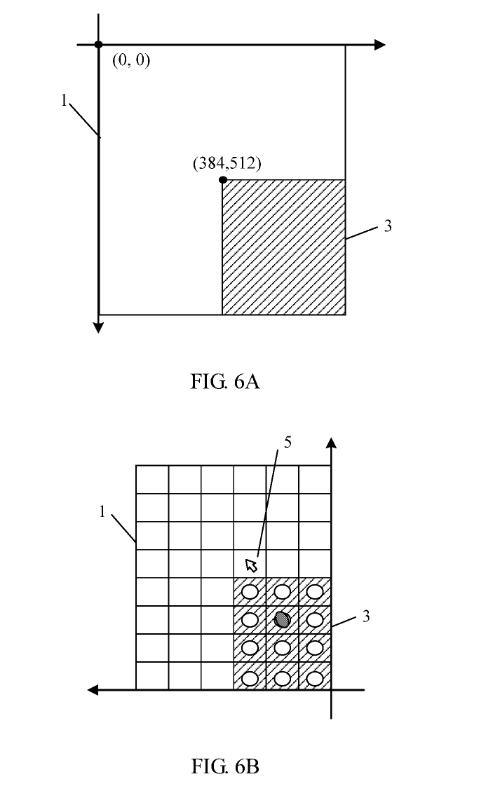

For example, as shown in FIG. 6A, a touchscreen 1 and a control region 3 above the touchscreen are included. It is assumed that a screen resolution of the touchscreen 1 is 768*1024, an area of the control region 3 is 384*512, and a top left corner of the touchscreen 1 is used as a calculation origin (0, 0); then, coordinates of a top left corner of the control region 3 are (384, 512). It is assumed that movement coordinates of the control region 3 are (x, y), and coordinates of a display location of the touchscreen 1 is (X, Y); then, a relationship between the display location of the touchscreen 1 and the movement coordinates of the control region 3 is: X=768−(768−x)*768/384, and Y=1024−(1024−y)*1024/512. Therefore, (X, Y)=(2x−768, 2y−1024).

As shown in FIG. 6B, the touchscreen 1 and the control region 3 above the touchscreen are included. It is assumed that the touchscreen 1 includes pixels of eight rows and six columns, and the control region 3 includes touch points of four rows and three columns; then, a touch point in the second row and the second column in the control region 3 is corresponding to a pixel in the fourth row and the fourth column in the touchscreen 1. When the touch point in the second row and the second column in the control region senses a corresponding touch, a cursor 5 moves to a location of the pixel in the fourth row and the fourth column in the touchscreen 1.

Certainly, when the correspondence between the touch point and the pixel of the touchscreen is a non-proportional scaling correspondence, it only needs to make a touch point in the control region corresponding to one pixel in the touchscreen.

Step 502: The terminal device acquires touch information of a touch point in the control region, where the touch information of the touch point includes acquired information about the touch point that is touched and acquired touch track information.

Step 503: The terminal device displays, according to the acquired information about the touch point that is touched and the correspondence between the touch point and the pixel of the touchscreen, a cursor at a pixel of the touchscreen corresponding to the touch point that is touched.

Step 504: The terminal device controls, according to the acquired touch track information, the cursor to move on the touchscreen in a track corresponding to the track information.

The track that is on the touchscreen and corresponding to the track information is obtained from the correspondence between the touch point and the pixel of the touchscreen.

Using this step can implement moving of the cursor displayed on the touchscreen by using the control region.

The terminal device performs real-time detection on the touchscreen, and when it is detected that the touchscreen is contact-touched, executes an operation corresponding to touch of a current location of the cursor.

When the control region is used to implement touch operations on the touchscreen, and when the user controls the cursor to move to a location to be touched, the user may click the touchscreen; when detecting that the touchscreen is clicked, the terminal device may execute the operation corresponding to touch of the location of the cursor. The location to be touched is, for example, a location of an application program to be run or a location of an operation to be run (for example, enabling a cellular data connection). When the cursor is moved to the location to be touched, the user may click any location of the touchscreen to make the terminal device execute an operation to be run, for example, open an application program to be run or execute an operation to be run. Therefore, in this embodiment of the present disclosure, the control region is created above the touchscreen, and operations on all the touchscreen are implemented by using the control region.

The terminal device may sense a suspended touch above the touchscreen by using a self-capacitive sensor, and sense a click on the touchscreen, that is, a contact-type touch, by using a mutual capacitive sensor.

The foregoing touchscreen control method may be applied to terminal devices such as mobile phones, tablet computers, and digital cameras.

### Embodiment 3

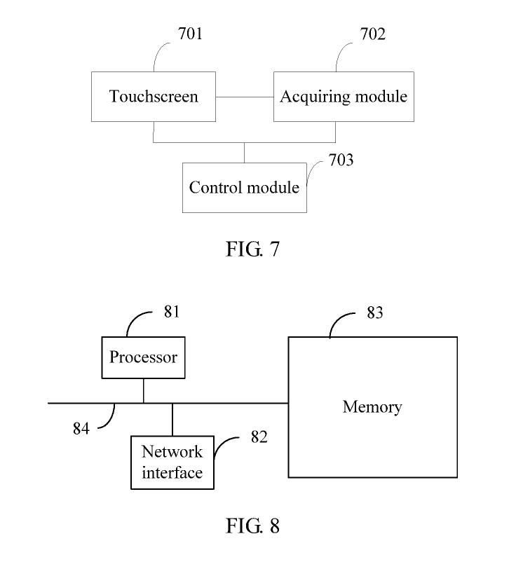

According to the foregoing Embodiment 1 and Embodiment 2, a third embodiment of the present disclosure provides a terminal device that includes a touchscreen 701, where a schematic structural diagram of the terminal device is shown in FIG. 7, and the terminal device further includes an acquiring module 702 configured to when the touchscreen is in a non-contact touch state, acquire touch information of a touch point in a control region; and transmit the acquired touch information of the touch point in the control region to a control module, where the control region is a region above the touchscreen, the control region is parallel to a plane in which the touchscreen is located, and an area of the control region is less than an area of the touchscreen; and the control module 703 configured to control movement of a cursor on the touchscreen according to the acquired touch information of the touch point and a correspondence between the touch point and a pixel of the touchscreen.

Further, the acquiring module is further configured to when the touchscreen is in the non-contact touch state, acquire information about the touch point that is touched, and acquire touch track information.

Further, the control module includes a display submodule configured to display, according to the acquired information about the touch point that is touched, the cursor at the pixel of the touchscreen corresponding to the touch point that is touched; and a control submodule configured to control, according to the acquired touch track information, the cursor to move on the touchscreen in a track corresponding to the track information, where the track that is on the touchscreen and corresponding to the track information is obtained from the correspondence between the touch point and the pixel of the touchscreen.

Further, the correspondence between the touch point and the pixel of the touchscreen is a proportional scaling correspondence or a non-proportional scaling correspondence.

Further, the terminal device further includes a detecting module configured to detect whether the touchscreen is contact-touched and transmit a detection result to an execution module; and the execution module configured to when receiving a detection result that the touchscreen is contact-touched, execute an operation corresponding to touch of a current location of the cursor.

In this embodiment of the present disclosure, when a touchscreen is in a non-contact touch state, movement of a cursor on the touchscreen is controlled according to acquired touch information of a touch point in a control region and a correspondence between the touch point and a pixel of the touchscreen, so that the entire touchscreen is controlled. An area of the control region is less than an area of the touchscreen. Therefore, a user can control a larger-area touchscreen by using a smaller-area control region, so that the user can perform one-hand operations.

### Embodiment 4

In a fourth embodiment of the present disclosure, as shown in FIG. 8, the terminal device in the foregoing embodiment may include at least one processor 81 (such as a central processing unit (CPU)), at least one network interface 82 or other communications interface, a memory 83, and at least one communications bus 84 that implements connection and communication between the apparatuses. The processor 81 is configured to execute an executable module stored in the memory 83, for example, a computer program. The memory 83 may include a high-speed random-access memory (RAM), and may also include a non-volatile memory, such as at least one magnetic disk memory. Through the at least one network interface 82 (wired or wireless), a system gateway communicates with at least one other network element on the Internet, a wide area network, a local area network, a metropolitan area network, and the like.

The memory 83 may be configured to store a program. In some implementation manners, the processor 81 executes a program in the memory to perform the following operations: when a touchscreen is in a non-contact touch state, acquiring touch information of a touch point in a control region, where the control region is a region above the touchscreen, the control region is parallel to a plane in which the touchscreen is located, and an area of the control region is less than an area of the touchscreen; and controlling movement of a cursor on the touchscreen according to the acquired touch information of the touch point and a correspondence between the touch point and a pixel of the touchscreen.

Further, the acquired touch information of the touch point includes acquired information about the touch point that is touched and acquired touch track information.

Further, that the processor 81 controls the movement of the cursor on the touchscreen according to the acquired touch information of the touch point and the correspondence between the touch point and the pixel of the touchscreen may specifically include that the processor 81 displays, according to the acquired information about the touch point that is touched, the cursor at the pixel of the touchscreen corresponding to the touch point that is touched; and controls, according to the acquired touch track information, the cursor to move on the touchscreen in a track corresponding to the track information, where the track that is on the touchscreen and corresponding to the track information is obtained from the correspondence between the touch point and the pixel of the touchscreen.

Further, the correspondence between the touch point and the pixel of the touchscreen is a proportional scaling correspondence or a non-proportional scaling correspondence.

Further, the processor 81 may further execute a program in the memory to perform the following operation when it is detected that the touchscreen is contact-touched, executing an operation corresponding to touch of a current location of the cursor.

A person of ordinary skill in the art may understand that, each aspect of the present disclosure or a possible implementation manner of each aspect may be specifically implemented as a system, a method, or a computer program product. Therefore, each aspect of the present disclosure or a possible implementation manner of each aspect may use forms of hardware only embodiments, software only embodiments (including firmware, resident software, and the like), or embodiments with a combination of software and hardware, which are uniformly referred to as “circuit”, “module”, or “system” herein. In addition, each aspect of the present disclosure or the possible implementation manner of each aspect may take a form of a computer program product, where the computer program product refers to computer-readable program code stored in a computer-readable medium.

The computer-readable medium may be a computer-readable signal medium or a computer-readable storage medium. The computer-readable storage medium includes but is not limited to an electronic, magnetic, optical, electromagnetic, infrared, or semi-conductive system, device, or apparatus, or any appropriate combination thereof, such as a RAM, a read-only memory (ROM), an erasable programmable read only memory (EPROM) or flash memory, an optical fiber, and a compact disc read only memory (CD-ROM).

A processor in a computer reads computer-readable program code stored in a computer-readable medium, so that the processor can perform a function and an action specified in each step or a combination of steps in a flowchart; an apparatus is generated to implement a function and an action specified in each block or a combination of blocks in a block diagram.

All computer-readable program code may be executed on a user computer, or some may be executed on a user computer as a standalone software package, or some may be executed on a computer of a user while some is executed on a remote computer, or all the code may be executed on a remote computer or a server. It should also be noted that, in some alternative implementation solutions, each step in the flowcharts or functions specified in each block in the block diagrams may not occur in the illustrated order. For example, two consecutive steps or two blocks in the illustration, which are dependent on an involved function, may in fact be executed substantially at the same time, or these blocks may sometimes be executed in reverse order.

Obviously, a person skilled in the art can make various modifications and variations to the present disclosure without departing from the spirit and scope of the present disclosure. The present disclosure is intended to cover these modifications and variations provided that they fall in the scope of protection defined by the following claims and their equivalent technologies.

1. A touchscreen control method, comprising:
acquiring touch information of a touch point in a control region when a touchscreen is in a non-contact touch state, wherein the control region is a region above the touchscreen, wherein the control region is parallel to a plane in which the touchscreen is located, and wherein an area of the control region is less than an area of the touchscreen; and
controlling movement of a cursor on the touchscreen according to the acquired touch information of the touch point and a correspondence between the touch point and a pixel of the touchscreen.

2. The touchscreen control method according to claim 1, wherein the acquired touch information of the touch point comprises:
touch point information associated with the touch point that is touched; and
touch track information.

3. The touchscreen control method according to claim 2, wherein the controlling movement of the cursor on the touchscreen according to the acquired touch information of the touch point and the correspondence between the touch point and theft pixel of the touchscreen comprises:
displaying, according to the touch point information and the cursor at the pixel of the touchscreen corresponding to the touch point;
obtaining a track on the touchscreen according to the correspondence between the touch point and the pixel of the touchscreen, wherein the track on the touchscreen is corresponding to the track information; and
controlling, according to the touch track information, the cursor to move on the touchscreen along the track.

4. The touchscreen control method according to claim 1, wherein the correspondence between the touch point and the pixel of the touchscreen is a proportional scaling correspondence.

5. The touchscreen control method according to claim 1, further comprising:
detecting that the touchscreen is contact-touched; and
executing an operation corresponding to touch of a current location of the cursor when detecting that the touchscreen is contact-touched.

6.-10. (canceled)

11. The touchscreen control method according to claim 1, wherein the correspondence between the touch point and the pixel of the touchscreen is a non-proportional scaling correspondence.

12. The touchscreen control method according to claim 2, wherein the correspondence between the touch point and the pixel of the touchscreen is a proportional scaling correspondence or a non-proportional scaling correspondence.

13. The touchscreen control method according to claim 3, wherein the correspondence between the touch point and the pixel of the touchscreen is a proportional scaling correspondence or a non-proportional scaling correspondence.

14. The touchscreen control method according to claim 2, further comprising:
detecting that the touchscreen is contact-touched; and
executing an operation corresponding to touch of a current location of the cursor when detecting that the touchscreen is contact-touched.

15. The touchscreen control method according to claim 3, further comprising:
detecting that the touchscreen is contact-touched; and
executing an operation corresponding to touch of a current location of the cursor when detecting that the touchscreen is contact-touched.

16. A terminal device comprises:
a touchscreen;
a control region located at a region above the touchscreen and parallel to a plane at which the touchscreen is located, wherein an area of the control region is less than an area of the touchscreen;
a non-transitory computer readable medium configured to store program instructions; and
at least one processor coupled to the non-transitory computer readable medium and configured to execute the program instructions to:
acquire touch information of a touch point in the control region when the touchscreen is in a non-contact touch state; and
control movement of a cursor on the touchscreen according to the acquired touch information of the touch point and a correspondence between the touch point and a pixel of the touchscreen.

17. The terminal device according to claim 16, wherein the acquired touch information of the touch point comprises:
touch point information associated with the touch point that is touched; and
touch track information.

18. The terminal device according to claim 17, wherein the processor is further configured to execute the program instructions to control the movement of the cursor on the touchscreen according to the acquired touch information of the touch point and the correspondence between the touch point and the pixel of the touchscreen by:
displaying, according to the touch point information and the cursor at the pixel of the touchscreen corresponding to the touch point;
obtaining a track on the touchscreen according to the correspondence between the touch point and the pixel of the touchscreen, wherein the track on the touchscreen is corresponding to the track information; and
controlling, according to the touch track information, the cursor to move on the touchscreen along the track.

19. The terminal device according to claim 16, wherein the correspondence between the touch point and the pixel of the touchscreen is a proportional scaling correspondence.

20. The terminal device according to claim 16, wherein the correspondence between the touch point and the pixel of the touchscreen is a non-proportional scaling correspondence.

21. The terminal device according to claim 17, wherein the correspondence between the touch point and the pixel of the touchscreen is a proportional scaling correspondence or a non-proportional scaling correspondence.

22. The terminal device according to claim 18, wherein the correspondence between the touch point and the pixel of the touchscreen is a proportional scaling correspondence or a non-proportional scaling correspondence.

23. The terminal device according to claim 16, wherein the processor is further configured to execute the program instructions to:
detect that the touchscreen is contact-touched; and
execute an operation corresponding to touch of a current location of the cursor when detecting that the touchscreen is contact-touched.

24. The terminal device according to claim 17, wherein the processor is further configured to execute the program instructions to:
detect that the touchscreen is contact-touched; and
execute an operation corresponding to touch of a current location of the cursor when detecting that the touchscreen is contact-touched.

25. The terminal device according to claim 18, wherein the processor is further configured to execute the program instructions to:
detect that the touchscreen is contact-touched; and
execute an operation corresponding to touch of a current location of the cursor when detecting that the touchscreen is contact-touched.
